(19) United States
(12) Patent Application Publication
(10) Pub. No.: US 2026/0278770 A1
(43) Pub. Date: Sep. 17, 2026

(54) AUTOMATIC LAYOUT BASED PATTERN RECOGNITION SEARCH

(71) Applicant: Applied Materials Israel Ltd., Rehovot (IL)

(72) Inventors: Pierre Jean-Marie Julien CHEVALIER, Grenoble (FR); Frederic Sebastien ROBERT, Grenoble (FR); Charles Robert Jérémie VALADE, Fontaine (FR)

(21) Appl. No.: 19/078,131

(22) Filed: Mar. 12, 2025

(51) Int. Cl. G06T 7/00; G06T 7/50

(52) U.S. Cl. CPC G06T 7/0006; G06T 7/50; G06T 2207/30148

(57) ABSTRACT

A system for identifying alignment areas for the examination of semiconductor specimens, which includes processing circuitry. The processing circuitry is configured to obtain a layout file specifying the layout of a semiconductor element. A set of candidate areas for aligning an examination tool to image a specimen of the semiconductor element at a desired location is generated by performing a polygon density analysis. The polygon density analysis identifies areas within at least a portion of the layout that have a polygon density within a specified density range. The generated candidate set is sequentially filtered to remove candidate areas that are outside a specified distance range from the desired location from the candidate set, and to remove candidate areas that lack vertices within the candidate area from the candidate set. The filtered candidate set is provided for use by an examination tool for a semiconductor element.

### TECHNICAL FIELD

The present disclosure, in some embodiments thereof, relates to the field of examination of semiconductor specimens, and, more particularly, but not exclusively, to aligning a semiconductor specimen in an examination tool.

### BACKGROUND

Current demands for high density and performance, associated with ultra large-scale integration of fabricated devices, require submicron features, increased transistor and circuit speeds, and improved reliability. As semiconductor processes progress, pattern dimensions such as line width and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

Examination may be provided by using non-destructive examination tools during or after manufacture of the specimen to be examined. A variety of non-destructive examination tools includes, by way of non-limiting example, scanning electron microscopes, atomic force microscopes, optical inspection tools, etc.

Examination processes may include multiple examination steps. The manufacturing process of a semiconductor device may include various procedures such as etching, depositing, planarization, growth such as epitaxial growth, implantation, etc. The examination steps may be performed a multiplicity of times, for example after certain process procedures, and/or after the manufacturing of certain layers, or the like. Additionally, or alternatively, each examination step may be repeated multiple times, for example for different wafer locations, or for the same wafer locations with different examination settings.

During the examination processes at various steps during semiconductor fabrication, examination images may be acquired by examination tools. The examination images are processed for the purpose of examination operations such as detecting and classifying defects on specimens, as well as performing metrology-related operations.

### SUMMARY OF THE INVENTION

Some embodiments, according to the disclosure, provide a system, method, and computer program product for identifying alignment areas in a semiconductor layout to facilitate precise examination of semiconductor specimens by an examination tool.

At one or more stages during the manufacture of a semiconductor element, an examination tool may be configured to scan a specimen (e.g., an entire wafer, an entire die, or portions thereof) and to capture inspection images. The inspection images are analyzed to detect potential defects, for example during the manufacturing process. Prior to image capture, the wafer may be moved relative to the detector of the examination tool (or the wafer and the tool may move in opposite directions relative to each other), and the wafer may be scanned step-by-step by the examination tool.

In a first example, the examination tool may be a scanning electron microscope (SEM) which produces images of a specimen by scanning the specimen with a focused beam of electrons. Typically, the SEM scans a wafer that is mounted on a stage inside the SEM chamber. When acquiring images of a wafer in a SEM, a list of coordinates corresponding to measurement locations on the wafer is provided. For each location in the list, the SEM brings the wafer to the desired position and acquires the image.

In a second example, the examination tool is an optical inspection tool which captures optical images of the specimen.

In order to obtain a high degree of accuracy in defect detection, it is important that the specimen be aligned precisely within the field of view of the examination tool. However, due to stage error navigation, the examination tool may not fall exactly on the desired location, meaning that the acquired image could be inaccurate.

In some cases, in order to obtain exact alignment of the specimen, the examination tool (e.g., SEM) captures an image of the specimen at its current location. The image is analyzed to identify specific distinguishable features. If these distinguishable features are not at the expected location, the specimen location is corrected so that the features, and thus the specimen itself, are aligned correctly in the examination tool.

Embodiments of the disclosure provide a technical solution to the technical problem of identifying alignment areas for measurement tools in an accurate and reproducible manner. The technical solution presented herein processes data from a layout file, selects candidate alignment areas within the layout, and performs a sequential filtering process. At each stage of the filtering, candidate areas that do not meet the requirements for a particular characteristic are removed from the list. This process efficiently generates a filtered candidate set which meets specific requirements for multiple characteristics of the layout.

Embodiments of the disclosure may accommodate filtering for many different characteristics, each characteristic having specific requirements that may vary for different types of semiconductor elements.

After the final filtering stage, the filtered candidate set is provided for use by an examination tool to guide the examination of semiconductor specimens. The alignment areas in the filtered candidate set enable accurate and efficient alignment of the examination tool, thereby improving examination outcomes.

Among advantages of certain embodiments of the presently disclosed subject matter as described herein, is the ability to select an initial set of candidate alignment areas which fulfill strict initial conditions of the permitted polygon density in an alignment area. This approach results in a highly accurate initial set of alignment areas, eliminating further evaluation of areas which do not fulfill the fundamental polygon density requirement.

Among advantages of certain embodiments of the presently disclosed subject matter as described herein, is the ability to generate the initial set by direct analysis of a layout file defining the layout as vector-based geometric data such as GDSII or Open Artwork System Interchange Standard (OASIS). This approach eliminates a process step of rasterizing the layout data into an image, thereby reducing processing resource consumption. Furthermore, a polygon density analysis performed directly on the geometric data without rasterization ensures precision and avoids pixelation artifacts.

Among advantages of certain embodiments of the presently disclosed subject matter as described herein, is the sequential filtering by which the candidate list is reduced at each step. This approach minimizes the computational load, since the suitability of a candidate area based on a specific characteristic score is determined only for candidate areas that have not been removed from the candidate set in preceding filtering stages.

Among advantages of certain embodiments of the presently disclosed subject matter as described herein, is the ranking of candidate areas remaining in the filtered candidate set based on a weighted scoring system which provides a final score for each remaining candidate area based on scores calculated for each of the selection/filtering characteristics. Thus, for example, one characteristic may be given greater importance for one layer, and a different characteristic may be given greater importance for a different layer. These weights may be user tunable, providing for exact fulfillment of the user's requirements.

Among advantages of certain embodiments of the presently disclosed subject matter as described herein, is that the candidate area selection is performed automatically and completely reproducibly. This reduces inconsistencies which may arise when candidate areas are identified manually.

As used herein, the terms “alignment area” and “PR Model” mean an area in a layout of a semiconductor element that may be used by an examination tool to align a semiconductor specimen within the examination tool's field of view. The alignment area may be defined in any technically suitable matter, for example by specifying the center of an alignment area with a known shape and orientation, by specifying the corners of the alignment area, and so forth.

As used herein, the term “semiconductor element” should be expansively construed to cover any kind of physical objects or substrates, including wafers, masks, reticles, and other structures, combinations and/or parts thereof used for manufacturing semiconductor integrated circuits, magnetic heads, flat panel displays, and other semiconductor-fabricated articles.

As used herein, the term “specimen” means a physical semiconductor element which may be examined by an examination tool. The term “specimen” should be expansively construed to include an element at any stage at which the examination process may occur.

As used herein, the term “layout” means a representation of the physical design of a semiconductor element. For example, the layout may be a representation of one or more layers of the semiconductor element.

As used herein, the term “layout file” means a file that stores the layout data. Typically, the layout file is in an industry-standard format, such as GDSII or OASIS.

As used herein, the term “portion of a layout” means the part of the layout in which alignment areas are being identified, such as a layer or portion of a layer of the semiconductor element.

As used herein, according to some embodiments, the terms “sequential filtering” and “filtered sequentially” mean that the candidate set is filtered according to multiple characteristics separately and in a defined order. Examples are presented in Table 1 below.

In accordance with certain aspects of the presently disclosed subject matter, there is provided a system for identifying alignment areas for the examination of semiconductor specimens. The system includes processing circuitry, configured to: obtain a layout file specifying a layout of a semiconductor element; generate a candidate set comprising a plurality of candidate areas for aligning an examination tool to image a specimen of the semiconductor element at a desired location by performing a polygon density analysis to identify areas within at least a portion of the layout having a polygon density within a specified density range; sequentially filter the candidate set by removing candidate areas that are outside a specified distance range from the desired location from the candidate set, and removing candidate areas that lack features with vertices within the candidate area from the candidate set; and providing the filtered candidate set for use by an examination tool for a semiconductor element.

The processing circuitry is configured to further filter the candidate set prior to the providing by removing candidate areas that have a same pattern as at least one other candidate area within the candidate set.
(i). The processing circuitry is configured to associate a respective density score with each candidate area in the filtered candidate set based on a difference between a respective polygon density of the candidate area and a target polygon density.
(ii). The processing circuitry is further configured to associate a position score with each candidate area in the filtered candidate set based on a distance between the candidate area and the desired location.
(iii). The processing circuitry is further configured to associate a respective feature score with each of the candidate areas in the filtered candidate set based on a total area of the features within a respective candidate area.
(iv). The processing circuitry is further configured to associate a respective final score with each candidate area in the filtered candidate set, the final score being a weighted linear combination of a polygon density score, a position score, and a feature score of the candidate area.
(v). The processing circuitry is further configured to rank the candidate areas in the filtered candidate set based on at least the respective final scores.
(vi). The processing circuitry is further configured to provide the filtered candidate set as an annotated layout file of the semiconductor element.
(vii). The layout file specifies the layout as vector-based geometric data, and the density analysis is performed directly on the geometric data.

In accordance with other aspects of the presently disclosed subject matter, there is provided a method of identifying alignment areas for the examination of semiconductor specimens, the method comprising: obtaining a layout file specifying a layout of a semiconductor element; generating a candidate set comprising a plurality of candidate areas for aligning an examination tool to image a specimen of the semiconductor element at a desired location by performing a polygon density analysis to identify areas within at least a portion of the layout having a polygon density within a specified density range; and filtering the candidate set by sequentially removing candidate areas that are outside a specified distance range from the desired location from the candidate set, and removing candidate areas that lack features with vertices within the candidate area from the candidate set; and providing the filtered candidate set for use by an examination tool for a semiconductor element.

These other aspects of the disclosed subject matter may comprise one or more of features (i) to (viii) listed above with respect to the system, mutatis mutandis, in any desired combination or permutation which is technically possible.

In accordance with other aspects of the presently disclosed subject matter, there is provided a non-transitory computer readable medium comprising instructions that, when executed by a processor, cause the computer to perform any of the above-listed methods.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative, and are not intended to be necessarily limiting.

Some embodiments of the present disclosure may be embodied as a system, method, or computer program product. For example, some embodiments of the present disclosure may take the form of an entirely hardware embodiment, an entirely software embodiment (including firmware, resident software, micro code, etc.) or an embodiment combining software and hardware aspects that may all generally be referred to herein as a “circuit,” “module”, and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software, or by firmware, and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of the method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s, are optionally provided.

Some embodiments of the present disclosure may be described below with reference to flowchart illustrations and/or block diagrams. For example, illustrating exemplary methods and/or apparatus (systems) and/or computer program products according to embodiments of the present disclosure.

The flowchart and block diagrams in the figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or act or carry out combinations of special purpose hardware and computer instructions.

It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational devices to cause a series of operational steps to be performed e.g., on the computational device, other programmable apparatus and/or other devices to produce a computer implemented process, such that the instructions which execute provide processes for implementing the functions/acts specified in the flowchart and/or block diagram block or blocks.

### BRIEF DESCRIPTION OF THE DRAWINGS

In order to understand the invention, embodiments will now be described, by way of non-limiting example only, with reference to the accompanying drawings. Features shown in the drawings are meant to be illustrative of only some embodiments of the present disclosure, unless otherwise indicated. In the drawings like reference numerals are used to indicate corresponding parts.

In block diagrams and flowcharts, optional elements/components and optional stages may be included within dashed boxes.

In the figures:

FIGS. 1A-1B illustrate the limitations of SEM stage movement when examining a particular location on a semiconductor specimen;

FIG. 2 is a simplified illustration of pattern recognition for alignment of a specimen in an examination tool;

FIG. 3 shows examples of potentially desirable and undesirable candidates for alignment areas in an exemplary layout of a semiconductor element;

FIG. 4 is a simplified block diagram of a system for identifying alignment areas for the examination of semiconductor specimens, according to some embodiments of the disclosure;

FIG. 5 is a simplified flowchart of a method for identifying alignment areas for the examination of semiconductor specimens, according to some embodiments of the disclosure;

FIG. 6 is a simplified flowchart of a method for identifying alignment areas for the examination of semiconductor specimens, according to an exemplary embodiment of the disclosure;

FIG. 7 illustrates an exemplary illustration of densities of alignment areas;

FIG. 8 is a simplified graph of a linear density scoring, according to an exemplary embodiment of the disclosure;

FIG. 9 is a simplified graph of a linear position scoring, according to an exemplary embodiment of the disclosure;

FIG. 10 is a simplified example of geometrical filtering based on the number of vertices within the candidate area, according to an embodiment of the disclosure;

FIG. 11 is a simplified illustration of feature scoring, according to an exemplary embodiment of the disclosure; and

FIG. 12 is a simplified illustration of ranked candidate areas within the field of view (FOV) of an examination tool, according to an example of the disclosure.

The various embodiments of the present disclosure are described below with reference to the drawings, which are to be considered in all aspects as illustrative only and not restrictive in any manner.

Elements illustrated in the drawings are not necessarily to scale, emphasis instead being placed upon clearly illustrating the principles of embodiments of the present disclosure. Moreover, two different objects in the same figure may be drawn to different scales.

### DETAILED DESCRIPTION OF EMBODIMENTS

The present disclosure, in some embodiments thereof, relates to the field of examination of semiconductor specimens, and, more particularly, but not exclusively, to aligning a semiconductor specimen in an examination tool.

The process of semiconductor manufacturing often requires multiple sequential processing steps and/or layers, some of which could possibly cause errors that may lead to yield loss. Examples of various processing steps may include lithography, etching, depositing, planarization, growth (such as, e.g., epitaxial growth), and implantation, etc. Various examination operations, such as defect-related examination (e.g., defect detection, defect review, and defect classification, etc.), and/or metrology-related examination (e.g., critical dimension (CD) measurements, etc.), may be performed at different processing steps/layers during the manufacturing process to monitor and control the process. The examination operations may be performed a multiplicity of times, for example after certain processing steps, and/or after the manufacturing of certain layers, or the like.

Some embodiments of the disclosure relate to a system and method for processing layout-based data to identify and select suitable candidate areas from a layout file based on predefined screening criteria.

The principles, uses, and implementations of the teachings herein may be better understood with reference to the accompanying description and figures. Upon perusal of the description and figures present herein, one skilled in the art will be able to implement the teachings herein without undue effort or experimentation.

Before explaining at least one embodiment in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

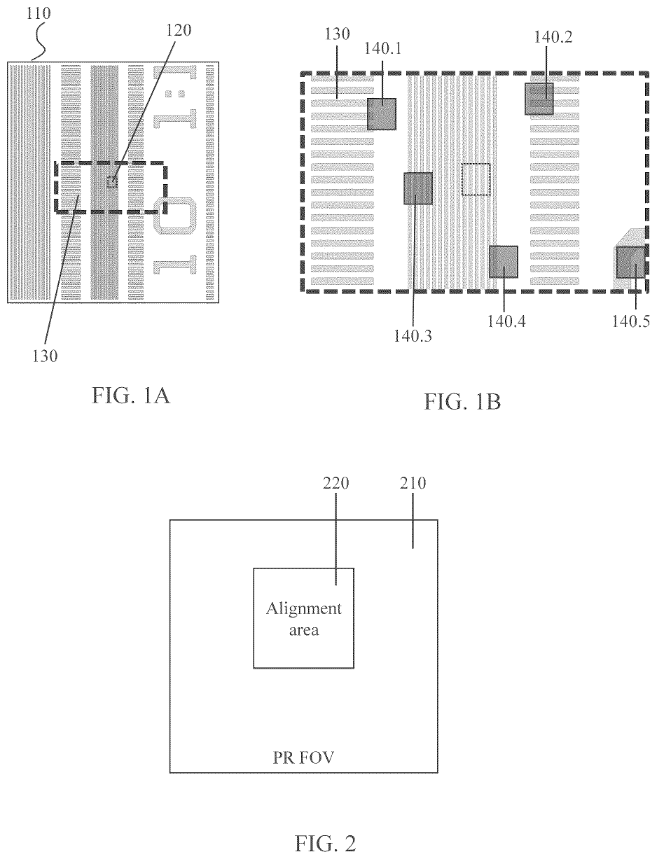

Referring now to the drawings, FIGS. 1A-1B illustrate limitations resulting from inaccuracies in SEM stage movement when examining a particular location on a semiconductor specimen. The same limitations may arise for other imaging examination tools that align the specimen in the field of view (FOV) of the examination tool.

Consider that a user wants to measure the vertical lines in layout 110 at measurement box (MB) 120, which lies within the examination tool's field of view 130. Due to navigation error, the examination tool may incorrectly end up imaging one of area 140.1-140.5 instead.

In some embodiments, pattern recognition is used to identify the actual location that the measuring tool is currently examining, by identifying an area having an expected pattern (also denoted herein as an alignment area or PR Model) within an image captured by the examination tool. The PR FOV is the field of view of the image the examination tool will acquire when looking for the PR. The PR Model size is a fraction of the size of the PR FOV.

Once the examination tool identifies the PR Model inside an acquired image, the examination tool may correct its positioning and acquire the MB image efficiently. In some cases, an auto-focus step may be performed between the pattern recognition and correcting the positioning of the specimen relative to the examination tool.

Reference is now made to FIG. 2, which is a simplified illustration of pattern recognition for the alignment of a specimen in an examination tool. PR FOV 210 schematically shows the field of view of an examination tool. Alignment area 220 is an area in the layout close to the measurement location (i.e., MB). For accurate pattern recognition, the pattern within alignment area 220 should have characteristics that enable an examination tool to identify the alignment area within the image. In some embodiments, the size of the alignment area (also denoted herein the sampling size) may be specified by a user.

Desired characteristics for an alignment area may include, but are not limited to, one, some, or all of the following:
1) Density—Favoring candidates with alignment areas having a suitable density of polygons.
2) Position—The distance between the alignment area and the MB should fall within a desired range. In order to prevent sample alteration, the distance should not be too close; however, the distance should not exceed a maximum distance.
3) Size and geometry—The pattern inside the alignment area should be big enough to be spotted and process-proof, and have distinct features within the alignment area (e.g., vertices).
4) Uniqueness—The pattern inside the alignment area should be unique enough not to be mistaken for another part of the layout close to it.
   Exemplary embodiments of some of the above characteristics are presented below.

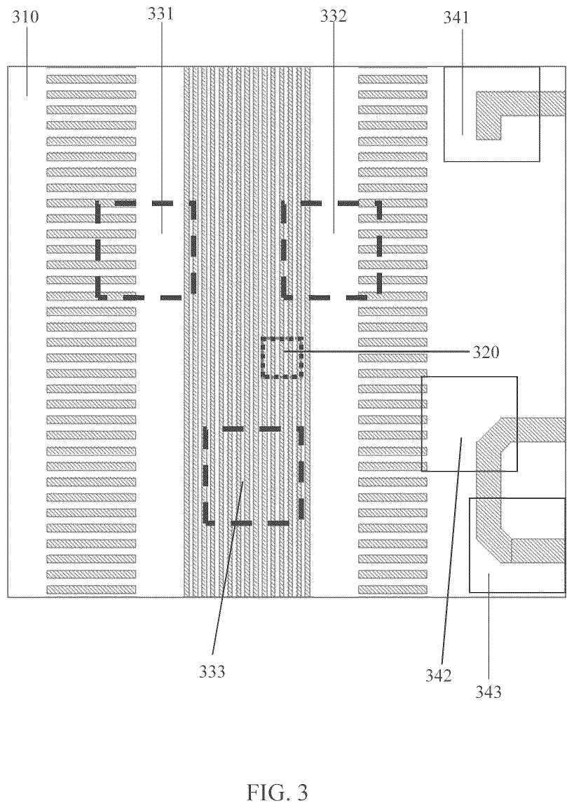

Reference is now made to FIG. 3, which shows examples of potentially desirable and undesirable candidates for alignment areas in an exemplary layout of a semiconductor element.

FOV 310 is a portion (or all) of the layout of a particular layer of the semiconductor element. MB 320 is the area in FOV 310 that is desired to be examined. Areas 331-333 and 341-344 are candidates for alignment areas which may be used to align a specimen at the correct location. Considering the density, distance, geometry, and uniqueness characteristics of these areas, areas 331-333 may be considered undesirable candidates, as the pattern within these candidate areas is not unique and identifiable. In contrast, areas 341-343 have distinguishing features (e.g., vertices and/or angled edges) which may make them suitable as alignment areas.

As used herein, the term “vertex” means a point where two or more edges meet to form a corner of a shape.

### I. System and Method for Identifying Alignment Areas for a Semiconductor Examination Tool

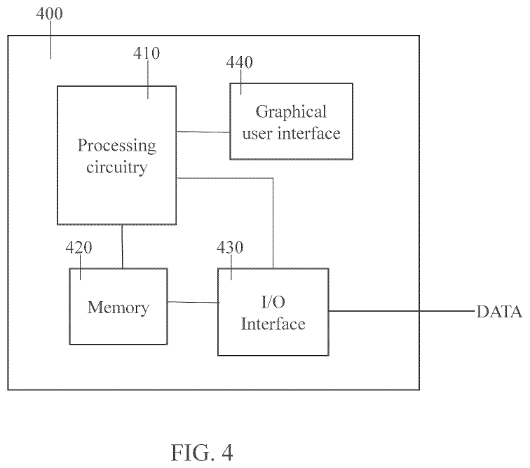

Reference is now made to FIG. 4, which is a simplified block diagram of a system for identifying alignment areas for the examination of semiconductor specimens, according to some embodiments of the disclosure. System 400 includes processing circuitry 410 which is configured to provide processing capabilities necessary for system 400, as described in more detail herein.

According to some embodiments of the disclosure, processing circuitry 410 is configured to obtain a layout file specifying the layout of a semiconductor element. According to some embodiments, processing circuitry 410 generates a candidate set within at least a portion of a layout of a semiconductor element. The candidate set includes multiple areas (denoted candidate areas) which are analyzed to determine whether they are suitable for aligning an examination tool to image a specimen of the semiconductor element at a desired location (e.g., the MB).

According to some embodiments of the disclosure, the candidate set is generated by performing a polygon density analysis of the portion of the layout in which alignment areas are being sought. The candidate set includes only areas of the layout having a polygon density within a specified range. Optionally, the candidate area has a specified size or range of sizes.

According to alternate optional embodiments of the disclosure, the candidate set is generated by a different type of analysis (e.g., by performing an analysis that identifies vertices in the layout). Optionally, the density characteristic is then used during the sequential filtering as an additional filtering characteristic.

After generating the candidate set, processing circuitry 410 filters the candidate set according to specified characteristics. After the candidate set is filtered, processing circuitry 410 provides a filtered candidate set which includes the remaining candidate areas, for use by an examination tool for a semiconductor element. Optionally, the candidate areas in the filtered candidate set are scored and/or ranked.

Filtering the candidate set is performed by removing candidates which do not have desired characteristics from the candidate set. The filtering process may be performed sequentially, where, at each stage, the candidate set is filtered based on a particular characteristic.

The processing circuitry 410 may comprise one or more processors (not shown separately), which may be associated with one or more memories (internal and/or external to system 400). The one or more processors of the processing circuitry 410 may be configured, either separately or in any appropriate combination, to execute several functional modules in accordance with computer-readable instructions implemented on a non-transitory computer-readable memory comprised in the processing circuitry. The operations of embodiments of the disclosure may be performed by multiple processors (or processor combinations) in processing circuitry 410, while, optionally, these operations may be performed by the same processor. The present disclosure should not be limited to being construed as one single processor always performing all the operations.

### I.1. Memory

Optionally, processing circuitry 410 includes one or more memories (denoted collectively memory 420), which stores data used by processing circuitry 410, possibly including but not limited to: the layout file (e.g. a GDSII or OASIS file), MB size, alignment area characteristics and criteria (e.g. optimal distance between candidate area and the location of the MB), and so forth. Accordingly, the different types of data, as required, may be retrieved from memory 420 and provided to processing circuitry 410 for further processing. The output of system 400, such as, e.g., the filtered candidate set of alignment areas, may be sent to memory 420 to be stored.

Additionally or alternately, memory 420 may store program instructions that, when executed by processing circuitry 410, cause processing circuitry 410 to perform any embodiment of the disclosure.

In some embodiments according to the disclosure, processing circuitry 410 is in communication with one or more external memories, and retrieves and/or stores data therein.

The terms “non-transitory computer-readable memory” and “non-transitory computer-readable storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of data and/or instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read-only memory (“ROM”), random access memory (“RAM”), magnetic disk storage media, optical storage media, flash memory devices, etc.

### 1.2. I/O Interface

Processing circuitry 410 may be operatively connected to a hardware-based input/output (I/O) interface 430. Optionally, processing circuitry 410 is configured to input information used during the analysis and identification process and/or to provide a set of recommended candidate areas (the filtered candidate set). In some embodiments, I/O interface 430 is in communication with a control system controlling the examination tool and/or the examination tool itself and/or any intermediate entity configured to provide and/or receive the relevant information.

In some embodiments, system 400 optionally includes a computer-based Graphical User Interface (GUI) 440, which is configured to enable user-specified inputs related to system 400. For instance, the user may be presented with a visual representation of the layout (or portion thereof), candidate areas, selected alignment areas, etc. The user may be provided, through the GUI, with options for defining certain operation parameters. The user may also view the operation results or intermediate processing results, such as rejected alignment areas, at any stage of the filtering process.

It should be noted that the system illustrated in FIG. 4 may be implemented in a distributed computing environment, in which one or more of the aforementioned components shown in FIG. 4 may be distributed over several local and/or remote devices.

It is to be noted that the teachings of the presently disclosed subject matter are not bound by the specific architecture of the systems as described herein.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

### 1.3. Processing a Set of Candidate Areas

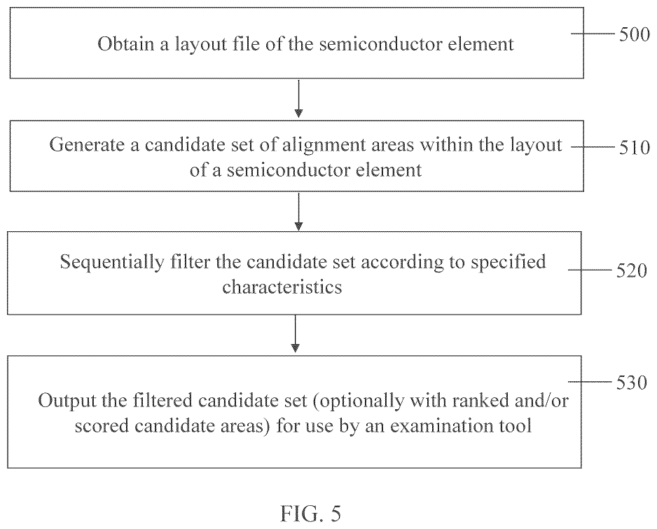

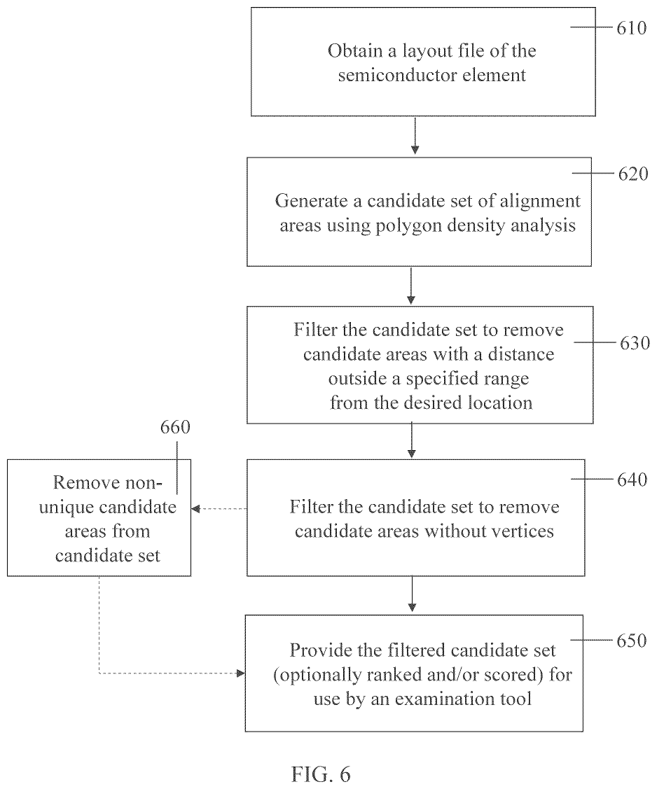

Reference is now made to FIG. 5, which is a simplified flowchart of a method for identifying alignment areas for the examination of semiconductor specimens, according to some embodiments of the disclosure. A more detailed example of a method for identifying alignment areas for the examination of semiconductor specimens according to a particular order of characteristics, is described below with respect to FIG. 6.

In 500, the layout file of a semiconductor element is obtained. The layout file specifies the layout of some or all of the semiconductor elements.

In 510, a candidate set is generated for the portion of the layout of a semiconductor element in which alignment areas are being sought. The candidate set includes candidate areas for aligning an examination tool to image a specimen of the semiconductor element at a desired location. In some embodiments of the disclosure, the candidate set is generated by performing a polygon density analysis to identify areas having a polygon density within a specified density range. Alternately or additionally, the candidate set is generated based on a different characteristic (such as distance from the desired location).

In 520, the candidate set is filtered sequentially according to specified criteria (e.g., 630-640 and optionally 660 of FIG. 6). At each filtering stage candidates which do not meet specified criteria for a given characteristic are removed from the candidate set.

In 530, after the filtering stages have been completed, a set of the candidate areas remaining in the candidate set (also denoted as filtered candidate set) is provided for use by an examination tool. Optionally, the candidate areas are specified by their location within the layout.

Optionally, during each stage of the filtering process, each remaining candidate area is scored according to the current filtering characteristic. For example, when the candidate areas in the candidate set are being filtered by distance, candidate areas closer to the optimal distance may be scored higher than those farther from the optimal distance. A final score for each candidate area may be calculated as a weighted linear combination of the candidate area's score at each of the filtering stages.

In some embodiments of the disclosure, processing circuitry 410 is further configured to rank the candidate areas in the filtered candidate set. Optionally, the ranking is based at least in part on the candidate areas' respective final scores.

According to some embodiments, the filtered candidate set is provided in an updated layout file.

Optionally, the filtered candidate set is provided for use by an examination tool by storing the updated layout file in an externally accessible memory (e.g., a database server).

Optionally, the filtered candidate set is provided by processing circuitry 410 in response to a query (for example, from a semiconductor developer). The query is associated with a particular layout or portion thereof. For example, the query may include the layout file, may provide a memory address to the layout file, or may refer to a layout file stored in an internal memory. Optionally, the filtered candidate set is made available to the source of the query, for example by sending an updated layout file back to the source of the query.

According to an embodiment of the disclosure, the updated layout file is an annotated layout file (such as an annotated GDSII or OASIS layout file). Optionally, the filtered candidate set is provided as an annotation layer in the updated layout file.

It is to be noted that the general approach of sequentially filtering the candidate set to eliminate candidate areas that do not have the desired characteristics may be performed using additional and/or alternate characteristics and criteria not expressly mentioned herein, and in different orders. Filtering by such characteristics may be included at any stage of the sequential filtering suitable to the presently disclosed subject matter (e.g., as a preliminary stage, final stage, or between two other stages).

Table 1 is a non-limiting list of examples of the order of characteristics used for analysis of the layout in order to identify suitable alignment areas. Examples of density, distance, and geometrical analysis are described in more detail below.

TABLE 1

| | First stage | Second stage | Third stage | Fourth stage |
|---|---|---|---|---|
| Example 1 | Density | Distance | Geometry | |
| Example 2 | Density | Distance | Geometry | Uniqueness |
| Example 3 | Density | Geometry | | |
| Example 4 | Density | Geometry | Distance | |
| Example 5 | Density | Geometry | Uniqueness | |
| Example 6 | Density | Geometry | Distance | Uniqueness |

Reference is now made to FIG. 6, which is a simplified flowchart of a method for identifying alignment areas for the examination of semiconductor specimens, according to an exemplary embodiment of the disclosure. FIG. 6 illustrates Examples 1 and 2, in which the candidate set is filtered in sequence by distance and geometry, and optionally uniqueness.

In 610, a candidate set is generated for the portion of the layout of a semiconductor element in which alignment areas are being sought. The candidate set includes candidate areas for aligning an examination tool to image a specimen of the semiconductor element at a desired location.

According to some embodiments of the disclosure, the candidate set is generated by performing a polygon density analysis to identify areas within at least a portion of said layout having a polygon density within a specified density range. The identified areas form the candidate set. Optionally, the polygon density is calculated as the ratio of polygons to void areas within the candidate area.

In some embodiments, the method further includes calculating a respective density score for each candidate area in the candidate set. Optionally, the density score is calculated from the difference between the polygon density of a given candidate area and a target polygon density.

In 630-640, the candidate set is filtered sequentially by distance and the presence of vertices in the candidate area (which may be considered an aspect of the geometry of the candidate area).

In 630, candidate areas that are outside a specified distance range from the desired location are removed from the candidate set.

In some embodiments, the method further includes calculating a position score for each candidate area in the filtered candidate set. Optionally, the position score is calculated from the distance between the candidate area and the desired location.

In 640, candidate areas that lack features with vertices within the candidate area are removed from the candidate set. In alternate or additional embodiments of the disclosure, candidate areas having other distinguishing features, such as angled and/or curved line(s), are retained in the candidate set.

In some embodiments, the method further includes calculating a respective feature score for each of the candidate areas in the filtered candidate set. Optionally, the feature score is calculated from the total area of the distinguishing features (e.g., areas containing vertices) within the candidate area.

In 650, after the filtering stages have been completed, the filtered candidate set is provided.

Optionally, in 660 candidate areas that have a substantially similar pattern, or are identical to at least one other candidate area within the candidate set, are removed from the candidate set, prior to providing the filtered candidate set in 650. This may create a candidate set where each candidate area has a unique pattern.

In some embodiments, the method further includes calculating a respective final score for each candidate area in the filtered candidate set. The final score of each candidate area may be a weighted linear combination of its density score, position score, and feature score.

In some embodiments, the method further includes ranking the candidate areas in the filtered candidate set based, at least in part, on the respective final scores.

According to some aspects of the disclosure, embodiments of any of the above-described methods may be performed by a processing system as described herein. The processing system may be configured to perform one or more of the following:
1) Obtaining a layout file of a semiconductor element;
2) Generating a candidate set, optionally based on polygon density analysis;
3) Filtering the candidate set based on distance from a desired location (e.g., from the location of the MB);
4) Filtering the candidate set based on distinguishing features (such as vertices);
5) Filtering the candidate set for uniqueness;
6) Calculating a respective density score for candidate areas;
7) Calculating a respective position score for candidate areas;
8) Calculating a respective feature score for candidate areas;
9) Calculating a respective final score for candidate areas based on the density score and/or position score and/or feature score; and
10) Ranking the candidate areas.

### II. Density Analysis

In some embodiments of the disclosure, density, D, is defined as the ratio between polygons and void areas for a given sampling size.

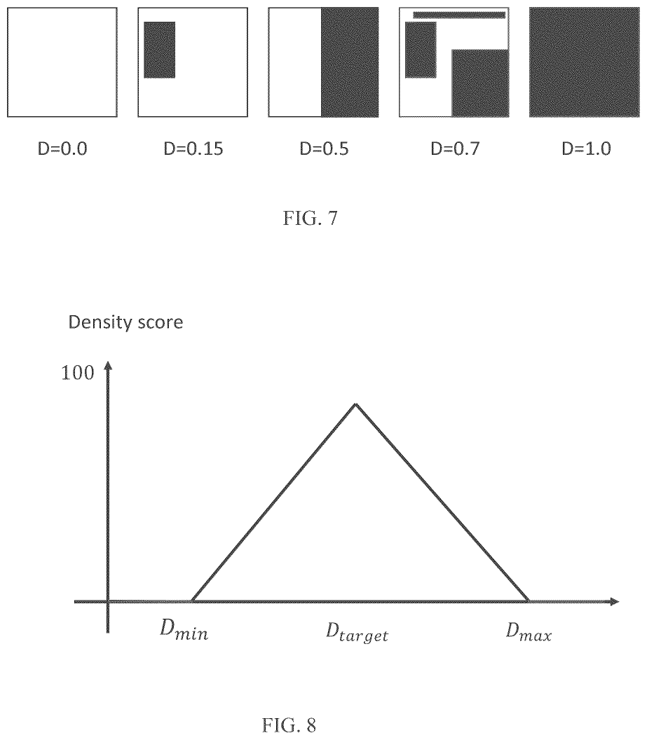

Reference is now made to FIG. 7, which illustrates this definition of density D. In the leftmost area D=0, since there are no polygons in the area. In the rightmost area D=1 as the entire area is filled with polygons. The intermediate examples show different ratios of polygons to void, and the corresponding density score.

Optionally, the sampling size is defined as a fraction of the size of the PR Model. For example, the sampling size may be one fourth of the PR Model size. However, other fractions may be used (e.g., the sampling size may be one eighth of the PR Model size).

The candidate areas are filtered according to a specified density range. Optionally, candidate areas having density values between a minimum Dₘᵢₙ and a maximum Dₘₐₓ are left in the candidate set, and candidate areas outside of this range are removed from the candidate set.

Optionally, a respective density score is calculated for each candidate area remaining in the candidate set. Candidate areas having a density value close to a target density value D_{target} are given higher scores than candidate areas having a density value farther from D_{target}. FIG. 8 is a simplified graph of an exemplary density scoring having a linear relationship between the density of the alignment area and D_{target}.

### III. Position Filtering

In some aspects of the disclosure, the candidate areas are filtered based on their relative position to MB. Optionally, candidate areas having a distance from MB between a minimum rₘᵢₙ and a maximum rₘₐₓ are retained in the candidate set and candidate areas outside of this range are removed from the candidate set.

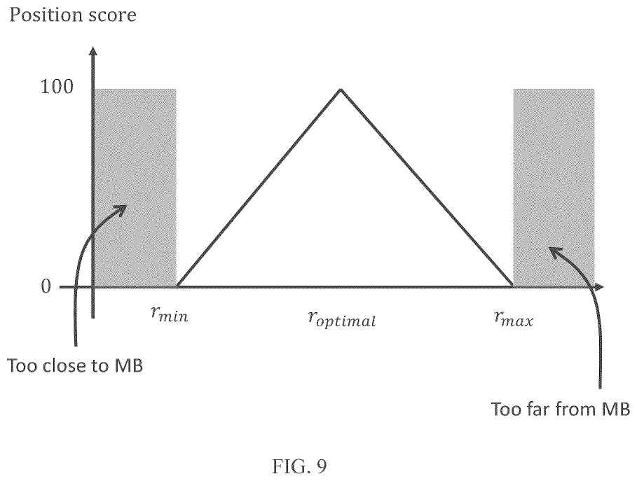

Optionally, a respective position score is calculated for each candidate area remaining in the candidate set based on the candidate area's distance from MB. Candidate areas having a distance close to a target distance value rₒₚₜᵢₘₐₗ are given higher scores than candidate areas having a distance farther from rₒₚₜᵢₘₐₗ. FIG. 9 is a simplified graph of position scoring based on a linear relationship between the distance of the alignment area from MB and rₒₚₜᵢₘₐₗ, according to an exemplary embodiment of the disclosure.

### IV. Geometrical Filtering

In some aspects of the disclosure, the candidate areas are filtered based on a geometrical characteristic, such as the number of vertices within the candidate area. Optionally, candidate areas having fewer vertices than a required number of vertices are removed from the candidate set.

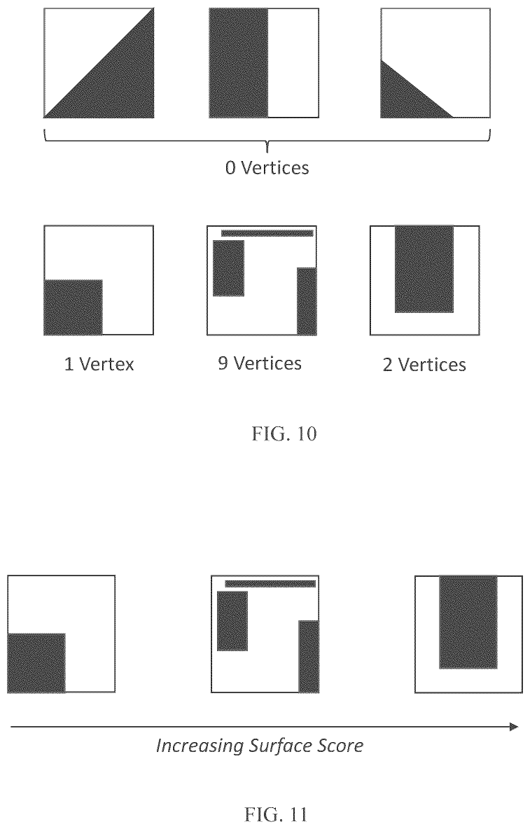

Reference is now made to FIG. 10, which is a simplified illustration of geometrical filtering based on the number of vertices within a candidate area, according to an exemplary embodiment of the disclosure. The top three candidate areas have zero vertices and may be removed from the candidate set. The bottom three candidate areas have one, nine, and two vertices, respectively. If the minimum required number of vertices is two, the candidate area with one vertex will be removed from the candidate set. Alternately, if the minimum required number of vertices is one, all three of the remaining candidate areas will be retained in the candidate set.

Optionally, a respective feature score is calculated for each candidate area remaining in the candidate set based on the area and number of polygons within the candidate area. In one example, the feature score is calculated as:

$${F}_{Score} = \frac{{S}_{Poly}}{{S}_{PRModel} \times {N}_{Poly}}$$

where S_{Poly} is the area of the polygons within the PR model, S_{PRModel} is the area of the PR model, and N_{Poly} is the number of polygons in the PR model.

In some cases, even candidate areas with very small features or even zero vertices may be retained in the candidate set. However, as they will have a low F_{Score} they may be removed from the candidate set at a later stage.

FIG. 11 is a simplified illustration of feature scoring based on the size of the features within the PR model, according to an exemplary embodiment of the disclosure. The surface score increases from left to right, in accordance with the area and number of polygons in the PR model.

### V. Final Score

According to some embodiments, a final PR_{Score} is calculated from the density score and/or the position score and/or the feature score.

In one example, the final PR_{Score} may be a weighted linear combination of all three scores:

$${PR}_{Score} = {D}_{Score} \times {w}_{D} + {P}_{Score} \times {w}_{P} + {F}_{Score} \times {w}_{F}$$

where:

| | |
|---|---|
| D_{Score} | Density Score [0, 100] |
| w_{D} | Density weight [0, 1] |
| P_{Score} | Position Score [0, 100] |
| w_{P} | Position weight [0, 1] |
| F_{Score} | Feature Score [0, 100] |
| w_{F} | Feature weight [0, 1] |

Optionally, the weights are user tunable. Thus, a user may emphasize one type of score with regard to others.

### VI. Filtered Candidate Set

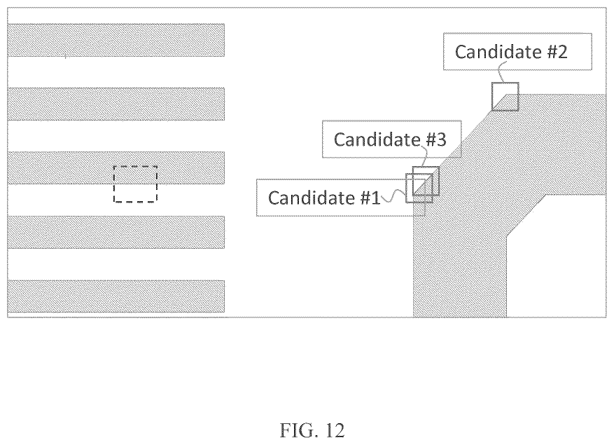

Reference is now made to FIG. 12, which is a simplified illustration of ranked candidate areas within the FOV of an examination tool, according to an example of the disclosure.

Candidate areas 1 and 2 both have a single vertex. Candidate area 1 is ranked higher than candidate area 2 because candidate area 1 has a higher feature score. Candidate area 3 does not have any vertices, and therefore ranks lower than candidate areas 1 and 2.

In summary, aspects of the disclosed subject matter present a system, method, and computer program product that may automate finding suitable alignment areas based on the layout of a semiconductor element and on specified criteria of characteristics of an alignment area. Such characteristics may include aspects such as polygon density, position relative to the measurement location MB, the size and number of features within it, and so forth. By automating the detection of alignment areas, efficiency, accuracy, and reproducibility are greatly increased relative to human detection of such areas.

### General

It is expected that during the life of a patent maturing from this application, many relevant pattern recognition technologies, semiconductor types, manufacturing/fabrication processes, semiconductor examination technologies and tools, as well as semiconductor elements, will be developed, and the scope of the terms pattern recognition, semiconductor examination, examination tool, semiconductor element, specimen, images of a specimen and imaging are intended to include all such new technologies a priori.

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references, unless the context clearly dictates otherwise.

Within this application, various quantifications and/or expressions may include use of ranges. Range format should not be construed as an inflexible limitation on the scope of the present disclosure. Accordingly, descriptions including ranges should be considered to have specifically disclosed all the possible sub-ranges, as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within the stated range and/or sub-range, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination, or may be suitable for use with any other described embodiment. Features described in the context of various embodiments are not to be considered essential features of those embodiments, unless the embodiment is inoperative without those elements.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Various modifications and changes may be applied to the embodiments of the present disclosure as hereinbefore described without departing from its scope, defined in and by the appended claims.

Where section headings are used in this document, they should not be interpreted as necessarily limiting.

1. A system for identifying alignment areas for the examination of semiconductor specimens, comprising:
a processing circuitry, configured to:
obtain a layout file specifying a layout of a semiconductor element;
generate a candidate set comprising a plurality of candidate areas for aligning an examination tool to image a specimen of said semiconductor element at a desired location by performing a polygon density analysis to identify areas within at least a portion of said layout having a polygon density within a specified density range;
filter said candidate set by sequentially performing:
removing candidate areas that are outside a specified distance range from said desired location from said candidate set; and
removing candidate areas that lack features with vertices within said candidate area from said candidate set; and
providing said filtered candidate set for use by an examination tool for a semiconductor element.

2. The system of claim 1, wherein said processing circuitry is configured to further filter said candidate set prior to said providing by removing candidate areas that have a same pattern as at least one other candidate area within said candidate set.

3. The system of claim 1, wherein said processing circuitry is further configured to associate a respective density score with each candidate area in said filtered candidate set based on a difference between a respective polygon density of said candidate area and a target polygon density.

4. The system of claim 1, wherein said processing circuitry is further configured to associate a position score with each candidate area in said filtered candidate set based on a distance between said candidate area and said desired location.

5. The system of claim 1, wherein said processing circuitry is further configured to associate a respective feature score with each of said candidate areas in said filtered candidate set based on a total area of said features within a respective candidate area.

6. The system of claim 1, wherein said processing circuitry is further configured to associate a respective final score with each candidate area in said filtered candidate set, said final score being a weighted linear combination of a polygon density score, a position score, and a feature score of said candidate area.

7. The system of claim 6, wherein said processing circuitry is further configured to rank said candidate areas in said filtered candidate set based on at least said respective final scores.

8. The system of claim 1, wherein said processing circuitry is configured to provide said filtered candidate set as an annotated layout file of said semiconductor element.

9. The system of claim 1, wherein said layout file specifies said layout as vector-based geometric data and said density analysis is performed directly on said geometric data.

10. A method of identifying alignment areas for the examination of semiconductor specimens, the method comprising:
obtaining a layout file specifying a layout of a semiconductor element;
generating a candidate set comprising a plurality of candidate areas for aligning an examination tool to image a specimen of said semiconductor element at a desired location by performing a polygon density analysis to identify areas within at least a portion of said layout having a polygon density within a specified density range;
filtering said candidate set by sequentially performing:
removing candidate areas that are outside a specified distance range from said desired location from said candidate set; and
removing candidate areas that lack features with vertices within said candidate area from said candidate set; and
providing said filtered candidate set for use by an examination tool for a semiconductor element.

11. The method of claim 10, further filtering said candidate set prior to said providing by removing from said candidate set candidate areas that have a substantially similar pattern to at least one other candidate area within said candidate set.

12. The method of claim 10, further comprising associating a respective density score with each candidate area in said filtered candidate set based on a difference between a respective polygon density and a target polygon density.

13. The method of claim 10, further comprising associating a position score with each candidate area in said filtered candidate set based on a distance between said candidate area and said desired location.

14. The method of claim 10, further comprising associating a respective feature score with each of said candidate areas in said filtered candidate set based on a total area of said features within a respective candidate area.

15. The method of claim 10, further comprising associating a respective final score with each candidate area in said filtered candidate set, said final score being a weighted linear combination of a polygon density score, a position score, and a feature score of said candidate area.

16. The method of claim 15, further comprising ranking said candidate areas in said filtered candidate set based on at least said respective final scores.

17. The method of claim 10, wherein said providing said filtered candidate set comprises generating an annotated layout file of said semiconductor element, said annotated layout file comprising said filtered candidate set as an annotation layer.

18. The method of claim 10, wherein said layout file specifies said layout as vector-based geometric data and said density analysis is performed directly on said geometric data.

19. A non-transitory computer readable storage medium tangibly embodying a program of instructions that, when executed by a computer, cause the computer to perform a method of identifying alignment areas for the examination of semiconductor specimens, said method comprising:
generating a candidate set comprising a plurality of candidate areas for aligning an examination tool to image a specimen of said semiconductor element at a desired location by performing a polygon density analysis to identify areas having a polygon density within a specified density range within at least a portion of a layout of a semiconductor element;
filtering said candidate set by sequentially performing:
removing candidate areas that are outside a specified distance range from said desired location from said candidate set; and
removing candidate areas that lack features with vertices within said candidate area from said candidate set; and
providing said filtered candidate set for use by an examination tool for a semiconductor element.
